(19) United States
(12) Patent Application Publication
(10) Pub. No.: US 2009/0017367 A1
(43) Pub. Date: Jan. 15, 2009

(54) POWER MODULE

(76) Inventor: Norio Marubayashi, Hyogo (JP)

Correspondence Address: MCDERMOTT WILL & EMERY LLP, 600 13TH STREET, NW, WASHINGTON, DC, 20005-3096, US

(21) Appl. No.: 12/170,161

(22) Filed: Jul. 9, 2008

(30) Foreign Application Priority Data
Jul. 10, 2007 (JP) 2007-181235

(51) Int. Cl. H01M 2/10; H01M 6/42

(52) U.S. Cl. 429/99; 429/156

(57) ABSTRACT

The power module of the invention includes: a cell stack including a plurality of cells that are stacked; a pair of end plates pressing and sandwiching the cell stack in the stacking direction; and a binding member joining the pair of end plates. The binding member has a recess that fits with an edge of the cell stack extending in the stacking direction. This ensures that the cells are bound together firmly and reliably.

### FIELD OF THE INVENTION

The invention relates to a power module including a cell stack composed of a plurality of cells that are stacked, and more particularly, to a method for binding the cell stack.

### BACKGROUND OF THE INVENTION

Conventional power modules are battery modules including one or more cell assemblies each composed of a plurality of cells that are stacked.

For example, Japanese Laid-Open Patent Publication No. Hei 11-111349 proposes a power module including a battery module comprising a plurality of bar-like cell assemblies disposed in parallel, each of the cell assemblies being composed of a plurality of cylindrical cells that are connected in the axial direction in series, and a pair of synthetic resin end plates sandwiching the opposite ends of the respective cell assemblies. The pair of end plates have grooves conforming to the shape of the cells at the ends of the cell assemblies, and through-holes for exposing the electrode terminals. The opposite ends of the cell assemblies are fitted to the grooves of the pair of end plates to secure the cell assemblies. The number of the through-holes and the grooves are the same as the number of the cell assemblies. The outer faces of the end plates (the faces opposite to the faces with the grooves) are fitted with connecting members for connecting the adjacent cell assemblies in series. The opposite ends of the cell assemblies are secured to the connecting plates with bolts.

Also, Japanese Laid-Open Patent Publication No. 2003-331807 proposes a power module to prevent problems resulting from variations in the dimensions of the bar-like cell assemblies in the axial direction thereof in the above-described battery module. The power module includes the above-described battery module, a pair of end plates sandwiching the opposite ends of the cell assemblies, and plates disposed between the end plates and the cell assemblies and having through-holes for exposing the electrode terminals and connecting members for connecting the adjacent cell assemblies in series. It is proposed to make these connecting members adjustable in the axial direction.

However, in the case of a relatively large power module including a large number of batteries, due to variations in battery size, the dimensional accuracy of the grooves of the end plates needs to be high, which results in increased costs. Also, the cell assemblies are secured by being sandwiched by the end plates in the stacking direction. Even if the dimensional accuracy of the grooves of the end plates is high, there are slight gaps between the end plates and the cell assemblies. Thus, if a force such as vibrations is exerted in the direction parallel to the face of the end plate in contact with the cell assemblies, the connecting members may break. Also, as the size of the power module increases, the size of the end plates also increases, which makes the assembly very difficult.

In order to solve the above-stated problems with conventional art, it is an object of the invention to provide a power module in which a plurality of cells are firmly bound together in a reliable manner even when the cell size is relatively large. It is also another object of the invention to provide an inexpensive, highly reliable power module that can be assembled easily.

### BRIEF SUMMARY OF THE INVENTION

A power module of the invention includes: a cell stack comprising a plurality of cells that are stacked; a pair of end plates pressing and sandwiching the cell stack in the stacking direction; and a binding member joining the pair of end plates. The binding member has a recess that fits with an edge of the cell stack extending in the stacking direction. According to the invention, even when the cell size is relatively large, it is possible to provide a power module in which a plurality of cells are firmly bound together in a reliable manner. It is also possible to provide an inexpensive, highly reliable power module that can be assembled easily.

When the cells and the end plates are substantially rectangular plates, it is preferred that the binding member comprise four binding beams that join the corners of the end plates, and that each of the four binding beams have a recess that fits with an edge of the cell stack extending in the stacking direction. Since the four edges of the cell stack extending in the stacking direction are fitted with the recesses of the four binding beams to fasten the cell stack with the four binding beams, the recesses of the binding beams do not require high dimensional accuracy and thus the production cost can be reduced.

It is preferred to provide an auxiliary binding member capable of joining a pair of adjacent binding beams and clamping the cell stack in a direction perpendicular to the stacking direction. Since the cell stack is clamped by the auxiliary binding member in a direction perpendicular to the stacking direction of the cells as well as by the end plates in the stacking direction of the cells, the cell stack can be bound more firmly.

Preferably, each of the cells has a positive electrode terminal on one end face thereof and has a negative electrode terminal on the other end face which is opposite to said one end face, and said one end faces and said the other end faces of the cells are alternately aligned on one plane of the cell stack, so that the positive electrode terminals and the negative electrode terminals are alternately aligned on one plane of the cell stack. In this case, the cell stack preferably has connecting plates for electrically connecting the positive electrode terminals and the negative electrode terminals.

Each of the connecting plates is preferably Z-shaped in a cross section that includes a direction parallel to the stacking direction of the cells and a direction perpendicular to the face of the connecting plate that is attached to the cell stack. When the connecting plates of such shape are used, it is possible to absorb not only vibrations of the connecting plates in the direction perpendicular to the plane direction thereof (the faces of the connecting plates attached to the cell stack) but also vibrations of the connecting plates in the stacking direction of the cells. It is thus possible to prevent the connecting plates from becoming broken or insufficiently contacting the electrode terminals.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a perspective view of a power module 1 in one embodiment of the invention;

FIG. 2 is a perspective view of a binding beam 4a of the power module 1 illustrated in FIG. 1;

FIG. 3 is a perspective view of the main portion of a cell stack 10 of the power module 1 illustrated in FIG. 1;

FIG. 4 is a perspective view of a connecting plate 20 of the power module 1 illustrated in FIG. 1; and

FIG. 5 is a perspective view of a power module in another embodiment of the invention.

### DETAILED DESCRIPTION OF THE INVENTION

The invention relates to a power module including: a cell stack comprising a plurality of cells that are stacked; a pair of end plates pressing and sandwiching the cell stack in the stacking direction; and a binding member joining the pair of end plates. The binding member has a recess that fits with an edge of the cell stack extending in the stacking direction.

Even when the cell size is relatively large, it is possible to provide a power module in which a plurality of cells are firmly bound together in a reliable manner. It is also possible to provide an inexpensive, highly reliable power module that can be assembled easily.

Referring now to FIGS. 1 to 4, one embodiment of the power module according to the invention is hereinafter described, but the invention is not limited to the following embodiment.

FIG. 1 is a perspective view of a power module in one embodiment of the invention. In FIG. 1, the arrow P shows a direction parallel to the stacking direction of the cells, and the arrows Q and R show the directions perpendicular to the arrow P.

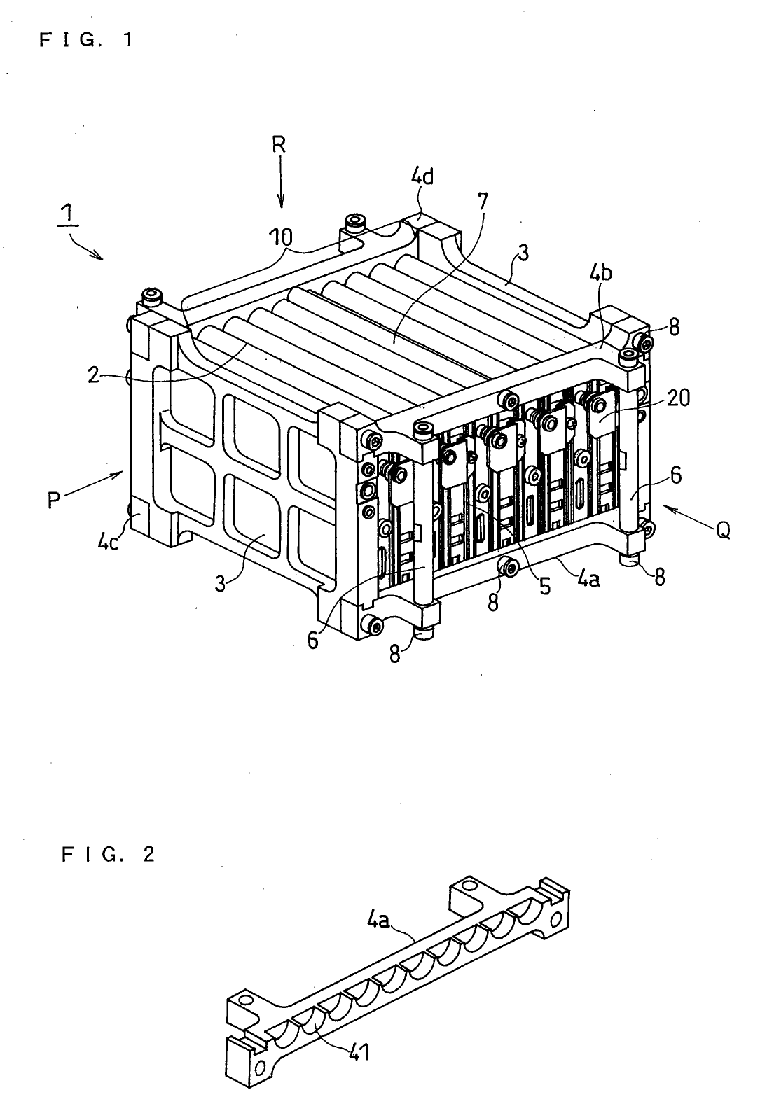

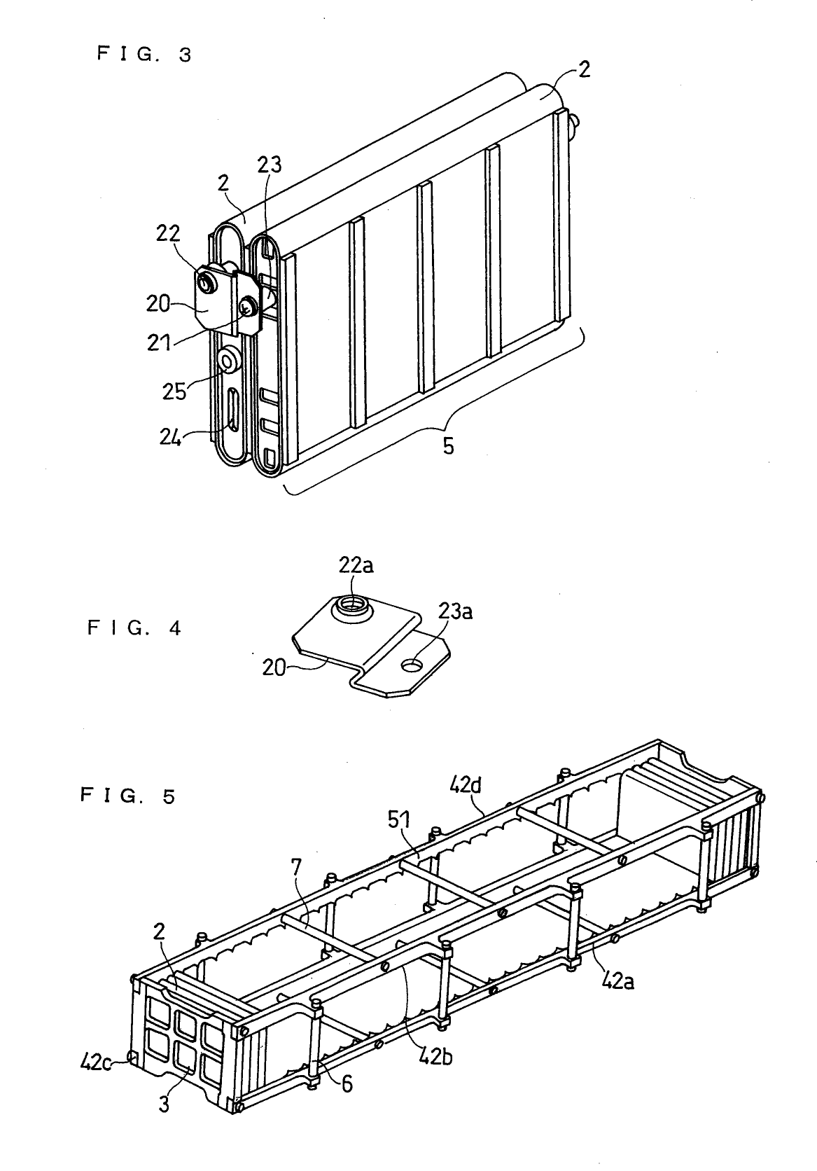

FIG. 2 is a perspective view of a binding beam 4a of the power module illustrated in FIG. 1. FIG. 3 is a perspective view of the main portion of a cell stack 10 of the power module 1 illustrated in FIG. 1. FIG. 4 is a perspective view of a connecting plate 20 of the power module 1 illustrated in FIG. 1.

As illustrated in FIG. 1, the power module 1 includes the cell stack 10 composed of ten rectangular cells 2 that are stacked in the thickness direction (the direction parallel to the arrow P in FIG. 1). The power module 1 further includes a pair of end plates 3 sandwiching the opposite faces of the cell stack 10 (the faces perpendicular to the stacking direction, i.e., the direction of the arrow P), and a binding member joining the pair of end plates 3. The cell stack 10 is secured by pressing of the pair of end plates 3 in the stacking direction (the direction parallel to the arrow P).

The binding member is composed of four bar-like binding beams 4a to 4d which join the four corners of the pair of end plates 3. Each of the binding beams 4a to 4d has a recess 41 that fits with an edge of the cell stack 10 extending in the stacking direction. The end plates 3 and the binding beams 4a to 4d are made of a light-weight, high-strength engineering plastic such as GF-PET (glass fiber reinforced polyethylene terephthalate) or PC (polycarbonate).

As illustrated in FIG. 2, the recess 41 is shaped so as to conform to the shape of the edge of the cell stack 10. As illustrated in FIG. 3, the end faces of the cells 2 corresponding to the upper and lower faces of the cell stack 10 are rounded and curved. Thus, the edges of the cell stack 10 extending in the stacking direction have ten successive curved portions. The recess 41 is shaped so as to conform to such ten curved portions. The recesses 41 of the four binding beams 4a to 4d fit with the four edges of the cell stack 10 extending in the stacking direction, whereby the cell stack 10 is secured and bound in the direction perpendicular to the stacking direction. There is thus no need to heighten the dimensional accuracy of the recesses 41, and cost reduction is possible. Since the binding beams 4a to 4d have the same shape, the power module can be easily assembled and cost reduction is possible.

The faces of the end plates 3 in contact with the cell stack 10 have hollows that conform to the shape of the cell stack 10. Hence, the cell stack 10 can be firmly sandwiched between the end plates 3, the displacement thereof can be prevented, and the assembly becomes easy. Also, since the cell stack 10 is bound using binding members in addition to the end plates 10, there is no need to heighten the dimensional accuracy of the hollows of the end plates 3, and cost reduction is possible.

The power module 1 includes an auxiliary binding member (made of, for example, anodized aluminum) composed of vertical tie rods 6 and longitudinal tie rods 7 which are capable of clamping the cell stack 10 in the directions perpendicular to the stacking direction (the direction parallel to the arrow P).

More specifically, the front face (the face seen from the direction of the arrow Q in FIG. 1) of the power module 1 is fitted with two vertical tie rods 6 that join the binding beam 4a and the binding beam 4b near the opposite ends thereof. Also, the back face (the face seen from the direction opposite to the arrow Q in FIG. 1) of the power module 1 is fitted with two vertical tie rods that join the binding beams 4c and the binding beam 4d near the opposite ends thereof. The cell stack 10 is clamped by the four vertical tie rods in the vertical direction (the direction parallel to the arrow R).

The upper face (the face seen from the direction of the arrow R in FIG. 1) of the power module 1 is fitted with a longitudinal tie rod 7 that join the binding beam 4b and the binding beam 4d in the center thereof. The lower face (the face seen from the direction opposite to the arrow R in FIG. 1) of the power module 1 is fitted with a longitudinal tie rod that connects the binding beam 4a and the binding beam 4c in the center thereof. The cell stack 10 is clamped by the two longitudinal tie rods in the longitudinal direction (the direction parallel to the arrow Q).

In this way, the cell stack 10 can be bound not only in the lateral direction of the cell stack 10 (the stacking direction of the cells) by the end plates 3, but also in the directions perpendicular to the stacking direction, i.e., the longitudinal direction and the vertical direction. In this way, since the cell stack 10 is bound from a plurality of directions, the cell stack 10 can be bound more firmly.

The binding beams 4a to 4d have threaded holes at positions to be joined to the end plates 3, vertical tie rods 6, and longitudinal tie rods 7. These members are secured by fitting bolts 8, made of, for example, stainless steel, into the threaded holes.

As illustrated in FIG. 3, in the cell stack 10, five bar-like spacers 5 (made of, for example, PC (polycarbonate)) are vertically disposed between the cells 2 at equal distances in order to prevent the cooling space from being closed when the cells 2 become expanded. The number and arrangement of the spacers are not limited to the one described above and may be determined as appropriate depending on the size and shape of the cells.

As illustrated in FIG. 3, adjacent two cells 2 are connected by one connecting plate 20 in series.

The cell 2 is a secondary battery in which an electrochemical device composed of a positive electrode, a negative electrode, and a separator interposed therebetween is housed in a metal battery case. Examples of such secondary batteries include nickel-metal hydride storage batteries and lithium ion secondary batteries. In the case of nickel-metal hydride storage batteries, nickel oxyhydroxide is used for the positive electrode, a hydrogen storage alloy for the negative electrode, and a potassium hydroxide aqueous solution for the electrolyte. Also, in the case of lithium ion secondary batteries, lithium cobaltate is used for the positive electrode, and a carbon material such as graphite for the negative electrode. Also, aluminum is used for the battery case and positive electrode terminal, and copper for the negative electrode terminal.

The cell 2 has a positive electrode terminal 22 on one end face thereof and has a negative electrode terminal 23 on the other end face which is opposite to the one end face. On the one end face, the cell 2 also has an explosion-proof valve 24 and a liquid inlet 25.

On one face (front face and back face) of the cell stack 10, one end faces and the other end faces of the cells are alternately aligned along the stacking direction, so that the positive electrode terminals 22 and the negative electrode terminals 23 are alternately aligned. The power module 1 has the connecting plates 20 each of which electrically connects the positive electrode terminal 22 and the negative electrode terminal 23 disposed on the end faces of adjacent two cells 2 (the faces corresponding to the front or back side of the power module 1). The adjacent two cells 2 can be connected in series by connecting the positive electrode terminal 22 and the negative electrode terminal 23 disposed adjacent. It is thus possible to make the size of the connecting plates 20 small and make the resistance of the connecting plates 20 low.

As illustrated in FIG. 3, the connecting plate 20 has a hole 22a for connecting the positive electrode terminal 22, and a hole 23a for connecting and securing the negative electrode terminal 23 using a screw 21. Specifically, the positive electrode terminal 22 is inserted through the hole 22a and then laser welded to the connecting plate 20. The connection between the negative electrode terminal 23 of the cell 2 and the connecting plate 20 is made by securing with the screw 21 and welding. The portion of the cell 2 to be connected with the connecting plate 20 can be shaped so that screwing or welding is easy.

Also, the connecting plate 20 is Z-shaped in a cross section that includes a direction parallel to the stacking direction of the cells 10 and a direction perpendicular to the face of the connecting plate 20 that is attached to the cell stack 10. That is, the connecting plate 20 is Z-shaped in a cross-section including directions parallel to the arrow P and the arrow Q.

In the connecting plate 20, the face in contact with the positive electrode terminal 22 is not flush with the face in contact with the negative electrode terminal 23. The connecting plate 20 is mounted on the cell stack 10 so that the face in contact with the positive electrode terminal 22 is higher than the face in contact with the negative electrode terminal 23 above the cells 2.

In this way, since the connecting plates 20 are folded into Z-shape, they have an elastic structure. Thus, they can absorb vibrations in the two directions, namely the longitudinal direction (the direction parallel to the arrow Q) and the lateral direction (the direction parallel to the arrow P) of the power module 1, thereby enabling prevention of the breakage of the connecting plates 20 due to vibrations. The connecting plates 20 are formed of, for example, aluminum, copper, or a cladding material of copper and nickel in order to achieve low resistance.

FIG. 5 shows another embodiment of the invention. FIG. 5 is a perspective view of a large-sized power module. In FIG. 5, the cell stack is composed of a larger number of cells 2 than in the power module of FIG. 1. In the power module of FIG. 5, the cells 2 are partly omitted. Also, components provided on the end faces of the cells 2, such as the positive electrode terminals, negative electrode terminals, and connecting plates, are omitted. As illustrated in FIG. 5, the large-sized power module can be easily formed by using long binding beams 42a to 42d, which have recesses 51 and are longer in the stacking direction than the binding beams 4a to 4d, instead of the binding beams 4a to 4d, and increasing the number of the long vertical tie rods 6 and the longitudinal tie rods 7.

In the above description, rectangular cells are incorporated in a power module, but for example, cylindrical cells may also be incorporated into a power module. In this case, since cylindrical bodies (curves faces) are aligned in contact with one another, space is created between the cylindrical cells. Thus, in the case of cylindrical cells, a power module can be formed without using the spacers 5.

The power module of the invention can be preferably used as a power source that is required to provide high power and large current such as for a hybrid car and as a large-sized back-up power source.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

1. A power module comprising:
a cell stack comprising a plurality of cells that are stacked;
a pair of end plates pressing and sandwiching the cell stack in the stacking direction; and
a binding member joining the pair of end plates,
wherein the binding member has a recess that fits with an edge of the cell stack extending in the stacking direction.

2. The power module in accordance with claim 1,
wherein the cells and the end plates are substantially rectangular plates,
the binding member comprises four binding beams that join the corners of the end plates, and
each of the four binding beams has a recess that fits with an edge of the cell stack extending in the stacking direction.

3. The power module in accordance with claim 2, further comprising an auxiliary binding member capable of joining a pair of adjacent binding beams and clamping the cell stack in a direction perpendicular to the stacking direction.

4. The power module in accordance with claim 2,
wherein each of the cells has a positive electrode terminal on one end face thereof and has a negative electrode terminal on the other end face which is opposite to said one end face, and
said one end faces and said the other end faces of the cells are alternately aligned on one plane of the cell stack, so that the positive electrode terminals and the negative electrode terminals are alternately aligned on one plane of the cell stack.

5. The power module in accordance with claim 4, wherein the cell stack has connecting plates for electrically connecting the positive electrode terminals and the negative electrode terminals.

6. The power module in accordance with claim 5, wherein each of the connecting plates is Z-shaped in a cross section that includes a direction parallel to the stacking direction of the cells and a direction perpendicular to the face of the connecting plate that is attached to the cell stack.
